(19) United States
(12) Patent Application Publication
(10) Pub. No.: US 2014/0091602 A1
(43) Pub. Date: Apr. 3, 2014

(54) SEAT ASSEMBLY FOR SADDLE RIDING TYPE AUTOMOTIVE VEHICLE

(71) Applicant: Kawasaki Jukogyo Kabushiki Kaisha, Hyogo (JP)

(72) Inventor: KENJI IDAKA, Akashi-shi (JP)

(73) Assignee: Kawasaki Jukogyo Kabushiki Kaisha, Hyogo (JP)

(21) Appl. No.: 14/033,094

(22) Filed: Sep. 20, 2013

(30) Foreign Application Priority Data
Sep. 28, 2012 (JP) 2012-215870

(51) Int. Cl. B62J 1/00

(52) U.S. Cl. CPC B62J 1/00
USPC 297/183.1

(57) ABSTRACT

A fellow passenger's seat (42) in a motorcycle includes a seat main body (54), having a cushioning material (62) covered by a surface skin (60), and a hand strap (56) disposed on an outer surface of the seat main body (54) and adapted to be gripped by a fellow passenger. The hand strap (56) includes a grip area (66) at a front end face (64) of the seat main body (54). A predetermined region (R) of the cushioning material (62), which confronts the grip area (66) of the hand strap (56), is more tenderized than a seating region (S) on which a rider is seated.

### CROSS REFERENCE TO THE RELATED APPLICATION

This application is based on and claims Convention priority to Japanese patent application No. 2012-215870, filed Sep. 28, 2012, the entire disclosure of which is herein incorporated by reference as a part of this application.

### BACKGROUND OF THE INVENTION

1. Field of the Invention

The present invention relates to a seat assembly for a saddle riding type automotive vehicle and, more particularly, to the seat assembly of a type including a seat main body, having a cushioning material covered with a surface skin, and a hand strap disposed on an outer surface of the seat main body for a fellow passenger to hold.

2. Description of Related Art

A seat assembly employed in a saddle riding type automotive vehicle such as, for example, a motorcycle generally includes a cushioning material filled between a surface skin and a bottom plate. In this type of the seat assembly, the use has been made of a hand strap provided in a front portion of a fellow passenger's seat so that a fellow passenger occupying the fellow passenger's seat may hold during the travel for the sake of safety. In this respect, see, for example, the Japanese Utility Model Registration No. 3157490.

It has however been found that in the seat assembly employed in the saddle riding type automotive vehicle, the cushioning material is packed so densely as to provide a high cushioning characteristic that is exhibited during the seating. For this reason, it has often been found difficult to insert fingers in between the surface skin and the hand strap. If the cushioning material is tenderized or softened to enable the fingers to be inserted in between the surface skin and the hand strap, the cushioning characteristic during the seating tends to be impaired. Also, if a clearance is provided to facilitate insertion of the fingers in between the surface skin and the hand strap, the hand strap will get saggy when and so long as the hand strap is not grasped, accompanied by disfigurement.

### SUMMARY OF THE INVENTION

The present invention has been devised in view of the problems and inconveniences in the prior art seat assemblies discussed above and is intended to provide a seat assembly for a saddle riding type automotive vehicle, in which the hand strap can be easily and comfortably grasped without being accompanied by a reduction in cushioning characteristic.

In order to accomplish the foregoing object, the present invention provides a seat assembly for a saddle riding type automotive vehicle of a kind including a seat main body, in which a cushioning material is covered with a surface skin, and a hand strap disposed on an outer surface of the seat main body to enable a fellow passenger to grasp such hand strap. In such case, a predetermined region of the cushioning material, which confronts a grip area of the hand strap, is more tenderized than a region that is occupied by a rider.

According to the structure, only the region of the cushioning material, which confronts the grip area of the hand strap, is tenderized and, therefore, an undesirable softening of a seating region can be prevented to thereby avoid a reduction in cushioning characteristic during the seating, and also insertion of fingers in between the surface skin and the hand strap can also be eased to facilitate the gripping of the hand strap.

In a preferred embodiment of the present invention, the hand strap referred to above is preferably disposed in a front end face of the seat main body. Where the hand strap is disposed in the front end face of the seat main body, the hand strap is short and has a small amount of deformation as compared with a hand strap disposed on an upper surface of the seat. As a result, while there may be a difficulty in gripping the hand strap, since the predetermined region confronting the grip area of the hand strap is tenderized, the hand strap can be easily and readily gripped.

In another preferred embodiment of the present invention, the cushioning material within the predetermined region preferably has a contact area that contacts the surface skin. According to this feature, the provision of the contact area makes it possible to allow the surface skin to be set up to an intended shape without allowing the outer shape of the predetermined region to lose shape.

In a further preferred embodiment of the present invention, against the contact area, a cavity is preferably formed on one side opposite to the surface skin to thereby permit the predetermined region to be tenderized. According to this feature, the predetermined region can be tenderized with a simplified structure.

Where the cavity is employed, the cavity is preferably formed in a portion of the seat, which is intermediate with respect to a direction widthwise of the vehicle. According to this feature, the portion of the seat, which is intermediate with respect to a direction widthwise of the vehicle, that is, an intermediate portion of the seat main body with respect to the direction widthwise of the vehicle that is generally gripped with a finger inserted, can be tenderized. As a result thereof, gripping of the hand strap can be facilitated, and also, the possibility of the surface skin losing shape at opposite end portions thereof in the widthwise direction of the vehicle can be avoided.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a side view showing a motorcycle equipped with a seat assembly designed in accordance with a first preferred embodiment of the present invention;

FIG. 2 is a side view of the seat assembly;

FIG. 3 is a top plan view of the seat assembly;

FIG. 4 is a cross sectional view taken along the line IV-IV in FIG. 3;

FIG. 5 is a cross sectional view taken along the line V-V in FIG. 3;

FIG. 6 is a transverse sectional view showing the seat assembly designed in accordance with a second preferred embodiment of the present invention;

FIG. 7 is a transverse sectional view showing the seat assembly designed in accordance with a third preferred embodiment of the present invention; and

FIG. 8 is a transverse sectional view showing the seat assembly designed in accordance with a fourth preferred embodiment of the present invention.

### DESCRIPTION OF PREFERRED EMBODIMENTS

Hereinafter, preferred embodiments of the present invention will be described in detail with particular reference to the accompanying drawings. Before the description of the present invention proceeds, it is to be noted that the terms “left” and “right” are used to denote opposite positions or directions, respectively, relative to a motorcycle rider or motorist then occupying a motorcycle rider's seat and looking forwards in a direction parallel to the longitudinal sense of the motorcycle.

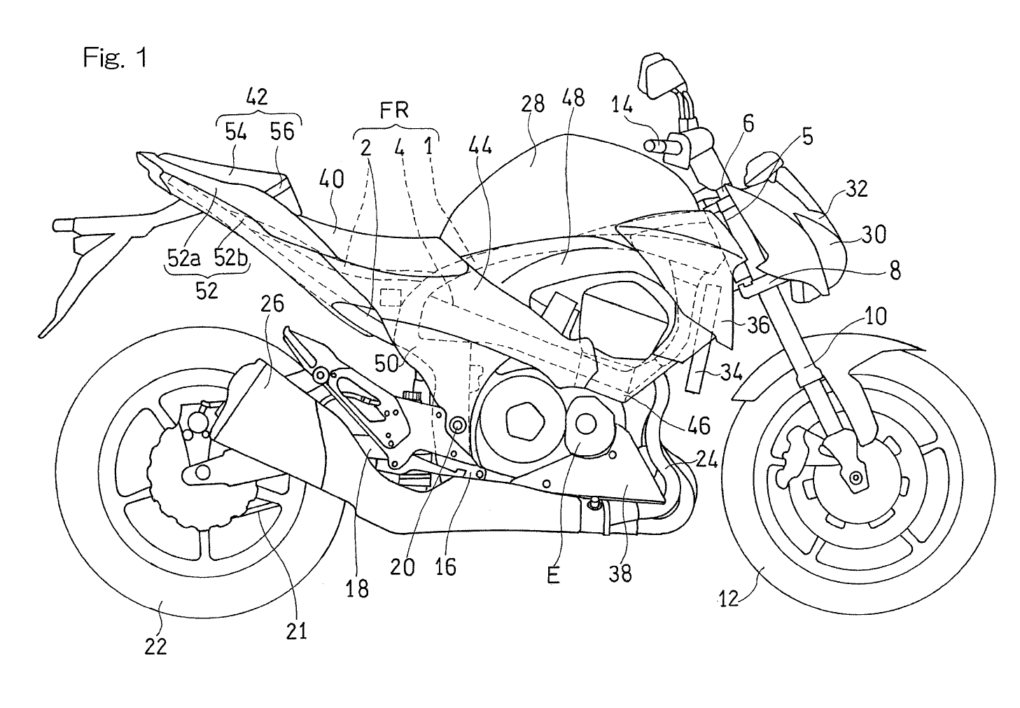

Referring to FIG. 1, there is shown a side view of a motorcycle, which is one kind of an saddle riding type automotive vehicle including a seat assembly designed in accordance with a first preferred embodiment of the present invention. A motorcycle frame assembly FR shown therein includes a main frame 1 forming a front half thereof, a rear frame 2 connected with a rear portion of the main frame 1 and forming a rear half thereof, and left and right paired subframes 4 extending from a front portion of the main frame 1 to the rear portion thereof. The left and right subframes 4 are positioned laterally outwardly of a motorcycle combustion engine E.

The main frame 1 has a front end to which a head tube 5 is fitted, and an upper bracket 6 and a lower bracket 8 are supported by the main frame 1 through a steering shaft (not shown) that is rotatably inserted into the head tube 5. A front fork assembly 10 is supported by the upper and lower brackets 6 and 8 and a front wheel 12 is rotatably supported at a lower end portion of the front fork assembly 10. The upper bracket 6 at an upper end portion of the front fork assembly 10 has a steering handlebar 14 mounted thereon for angular movement together with the front fork assembly 10.

A rear end portion of the main frame 1 is inclined rearwardly slantwise, and a swingarm bracket 16 is formed at this rear end portion of the main frame 1. A swingarm 18 has a front end portion pivotally supported by the swingarm bracket 16 through a pivot shaft 20, and a rear wheel 22 is rotatably supported by a rear end portion of this swingarm 18. The motorcycle combustion engine E, which is a drive source for the motorcycle, is mounted at a lower position of a substantially intermediate portion of the main frame 1 in a fashion tilted forwardly. The rear wheel 22 referred to above is driven by the combustion engine E through a transmission member 21 such as, for example, a substantially endless chain.

The motorcycle combustion engine E referred to above is an internal combustion engine and, in the practice of this preferred embodiment is a parallel multi-cylinder, water cooled internal combustion engine such as, for example, a four-cylinder, four-stroke water-cooled internal combustion engine. Four exhaust pipes 24 are connected with a front surface of the combustion engine E and are, after having been merged together at a location below the combustion engine E, fluid connected with a muffler 26 disposed on a right side of the rear wheel 22. A fuel tank 28 is disposed above the main frame 1. A headlamp unit 30 is supported at a front surface of the front fork assembly 10. A front cowl 32, made of a resinous material, is supported by the headlamp unit 30 so as to cover an area forwardly of an upper portion of the front fork assembly 10.

A radiator 34 for dissipating an engine coolant medium such as a water is disposed slantwise forwardly above the combustion engine E. Left and right paired cowls 36 are disposed so as to extend from laterally upwardly of the radiator 34 towards respective upper end portions of the subframe 4 and laterally outwardly of the front portion of the main frame 1 and are supported by the main frame 1. Left and right paired lower cowls 38, each made of a resinous material, are supported beneath the combustion engine E.

A rider's seat 40, which is a front seat, and a fellow passenger's seat 40, which is a rear seat, are mounted on an upper portion of the rear frame 2. A side covering 44 extends from below the rider's seat 40 to a rear portion of the combustion engine E so as to enclose a rear half portion of the subframe 4. A subframe covering 46, which extends from front end portions of the side covering 44 to a lower portion of the side cowls 36, is supported by the subframe 4 to thereby cover a front half portion of the subframe 4.

At upper and lower positions on both sides of the side covering 44, an upper frame covering 48 and a lower frame covering 50 are disposed respectively. The upper frame covering 48 referred to above extends from the side cowl 36 to the side covering 44 along a lower edge of the fuel tank 28 to thereby cover the main frame 1 from lateral outside. On the other hand, the lower frame covering 50 referred to above extends downwardly from the side covering 44 to thereby cover the swingarm bracket 16 from lateral outside. Also, a lower portion of the fellow passenger's seat 42 and the rear frame 2 therebelow are covered by a rear covering 52 including an upper rear portion 52a and a lower rear portion 52b from lateral outside. The rear covering 52 has a front end continued to a rear end of the side covering 44.

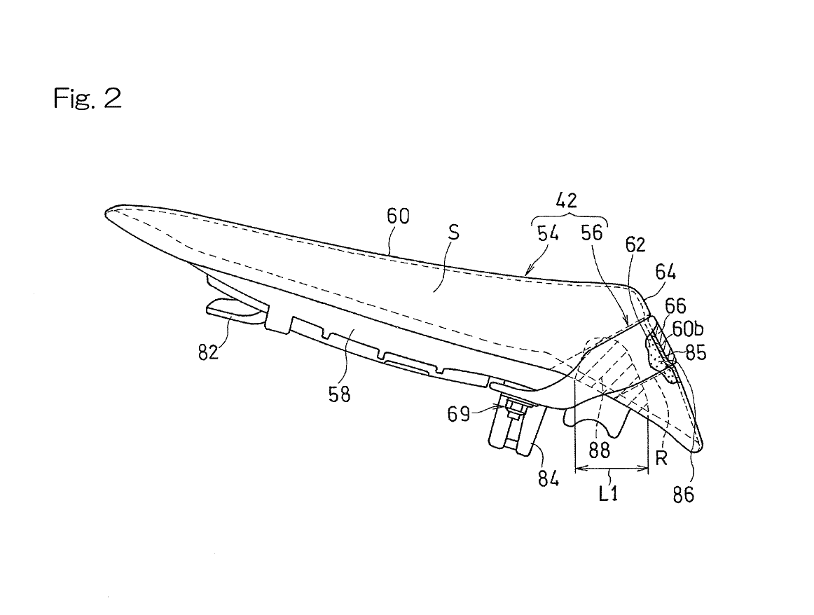

As shown in FIG. 2, the fellow passenger's seat 42 includes a seat main body 54 and a hand strap 56 disposed on an outer surface of the seat main body 54 so that a fellow passenger then occupying such seat 42 can grasp the hand strap 56. The seat main body 54 includes a bottom plate 58 supported by the rear frame 2 and made of a resinous material, a surface skin 60 made of a leather and forming an outer surface of the fellow passenger's seat 42, and a cushioning material 62 packed in between the bottom plate 58 and the surface skin 60. The cushioning material 62 is for securing a cushioning characteristic when the fellow passenger is seated and, in the embodiment now under discussion, urethane is employed as the cushioning material 62. It is, however, to be noted that material for the cushioning material 62 may not necessarily limited thereto.

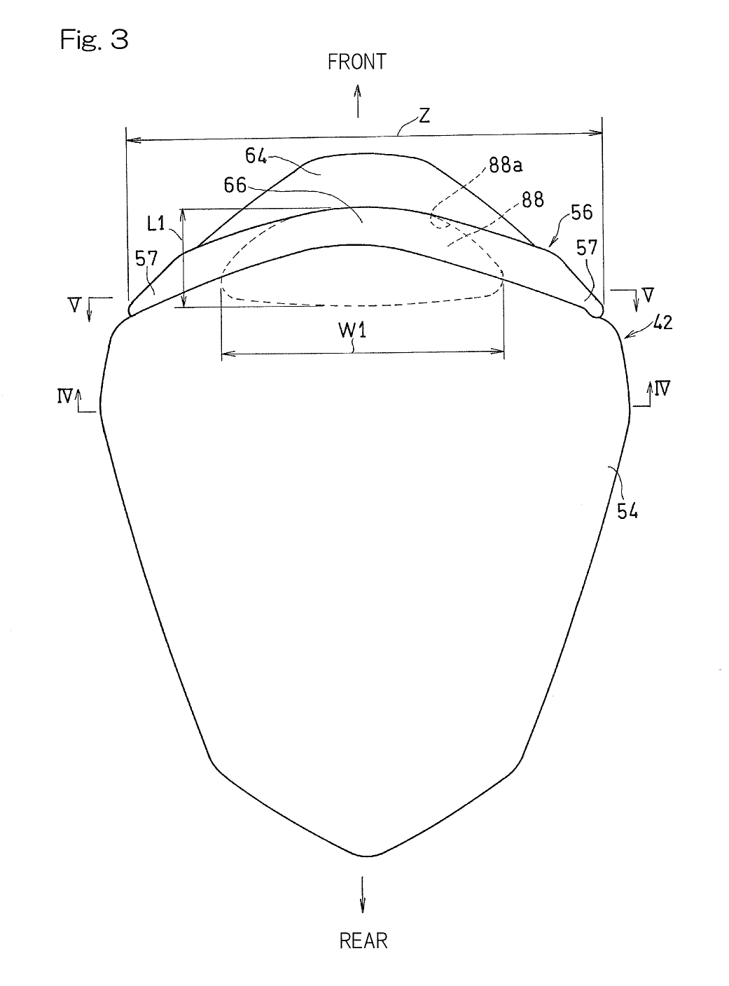

The seat main body 54 has a front end face 64 in the form of an inclined surface inclined rearwardly upwardly and, as viewed from top as shown in FIG. 3, represents a shape tapered in a forward direction. The hand strap 56 is made of a soft material having a low stretching property such as, for example, an artificial leather and is disposed in the front end face 54 of the seat main body 54. More specifically, the hand strap 56 shown in FIG. 3 has a grip area 66 that is grasped by the fellow passenger then occupying the fellow passenger's seat 42, and the grip area 66 is disposed in the front end face 64 of the seat main body 54. The grip area 66 is formed in a portion intermediate of a motorcycle widthwise direction excluding motorcycle widthwise opposite end portions 57. In this instance, the grip area 66 means a portion intermediate of the hand strap 56 of a length Z in the motorcycle widthwise direction, which portion occupies a length of 0.8Z. As shown in FIG. 2, the opposite end portions 57 of the hand strap 56 extends below the bottom plate 58 and are then fitted to the bottom plate 58 by respective fastening members 69.

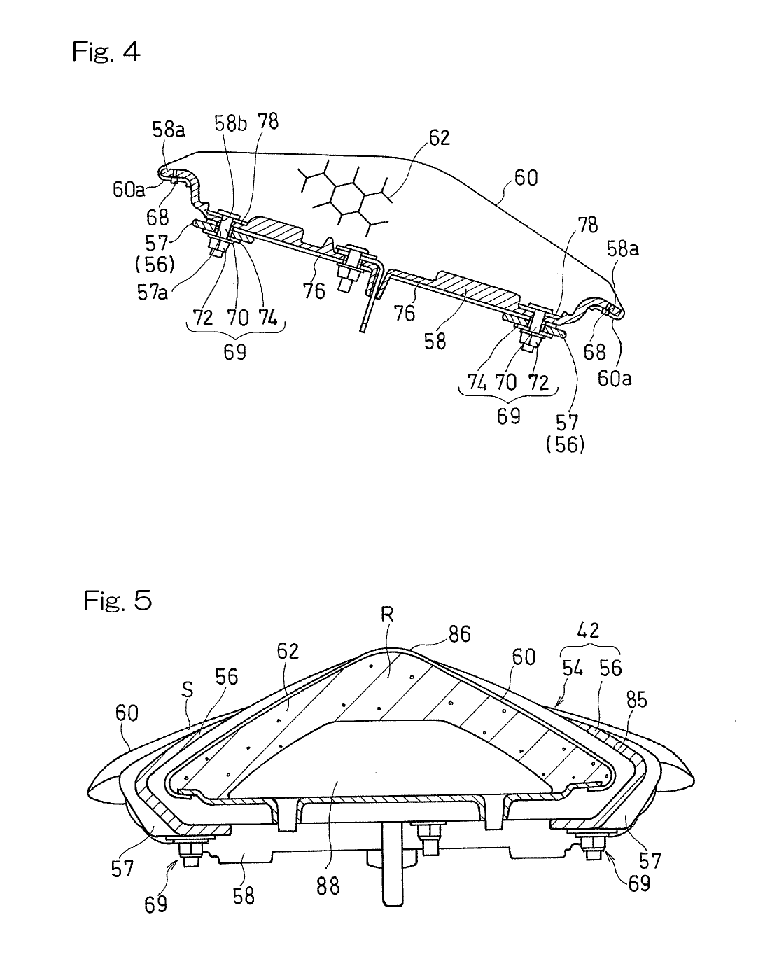

As shown in FIG. 4 showing a transverse sectional view, the cushioning material 62 is covered by the surface skin 60. The surface skin 60 has opposite side edge portions 60a and 60a that are bent downwardly of the bottom plate 58 and are then fitted to respective opposite side edge portions 58a and 58a of the bottom plate 58 by means of fitting members 68 such as, for example, staplers. Accordingly, with the cushioning material 62 packed inside, the bottom plate 58 and the surface skin 60 are connected together to thereby define the seat main body 54.

Each of the fastening members 69 referred to above includes a screw 70, inserted molded with and fixed to the bottom plate 58, a nut 72 and a washer 74. By inserting an insertion hole 57a, provided in each of the opposite end portions 57 of the hand strap 56, into the screw 70 and engaging the nut 72 with the screw 70 through the washer 74, the opposite end portions 57 of the hand strap 56 are fitted to an undersurface of the bottom plate 58. In this way, the fellow passenger's seat 42 is thereby formed.

An inner backing plate 78, made of a steel material, together with the screw 70, is provided between an upper surface of the bottom plate 58 and a head portion of the screw 70 by means of an insert molding technique. Also, an outer backing plate 76 made similarly of a steel material is disposed between the undersurface of the bottom plate 58 and an upper surface of each of the opposite end portions 57 of the hand strap 56. Those backing plates 76 and 78 reinforce respective portions of the resinous bottom plate 58 in vicinity of the fastening member 69. The fellow passenger's seat 42 referred to above is removably supported the rear frame 2 (shown in FIG. 1) in any known manner by the use of a rear engagement portion 82 and a front lock portion 84, both best shown in FIG. 2.

The surface skin 60 and the cushioning material 62 are formed with a storage groove 85 in which the grip area 66 of the hand strap 56 is accommodated. A predetermined region R of the cushioning material 62, which confronts the storage groove 85, that is, the grip area 66 of the hand strap 56, is more tenderized than a seating region S where the fellow passenger is seated. The seating region S is a region through which the passenger's weight is loaded to the bottom plate 58. This storage groove 85 extends across the upper surface of the surface skin 60 to a lower portion of the seat main body 54. The surface skin 60 retains the grip area 66 of the hand strap 56 at a retaining portion 60b forming a part of a bottom surface of the storage groove 85. The predetermined region R of the cushioning material 62 referred to hereinabove means a region extending substantially perpendicular to the retaining portion 60b of the surface skin 60 and lying between the retaining portion 60b and the bottom plate 58. It is, however, to be noted that the use of the storage groove 85 may not be necessarily essential and can therefore be dispensed with.

The cushioning material 62 in the predetermined region R has a contact area 86 that contacts the surface skin 60. On one side opposite to the contact area 86 in the predetermined region R, a cavity (recess) 88 having no cushioning material 62 filled therein is formed. By the presence of this cavity 88, the predetermined region R and its vicinity are thin walled, and as a result, at least the predetermined region R is tenderized relative to a direction perpendicular to the front end face 64. The cavity 88 is formed in a lower portion of the seat main body 54 so as to open in a downward direction of the cushioning material 62 and is, as best shown in FIG. 3, positioned in a portion of the seat main body 54 intermediate of the motorcycle widthwise direction.

The cavity 88 has an inner wall, a front surface 88a of which is of a shape conforming to the shape of the front end face 64. More specifically, the cavity 88 represents a substantially oval shape when viewed from top and also represents a bell shape having been smoothly recessed upwardly when viewed from side as shown in FIG. 2. The cavity 88, when viewed from front, represents a substantially trapezoidal shape as shown in FIG. 5 showing a transverse sectional view.

Anteroposterior and widthwise dimensions (the dimension as measured in a direction conforming to the longitudinal sense of the motorcycle and the dimension as measured in a bilateral direction of the motorcycle) are so formed as to be larger than a space of a size sufficient to accommodate some of the fingers then inserted in between the hand strap 56 and the surface skin 60. More specifically, as shown in FIG. 3, a lower opening of the cavity 88 has an anteroposterior length L1 which is preferably within the range of 10 to 60 mm, and also has a width W1 which is preferably within the range of 40 to 150 mm. More preferably, the cavity 88 is formed to such a size as to define the space enough to accommodate therein some of the fingers pulled on a glove and, specifically, the length L1 is so chosen to be within the range of 15 to 50 mm and the width W1 is so chosen to be within the range of 50 to 120 mm. If the longitudinal length L1 or the bilateral width W1 are so chosen to be greater than 60 mm or 150 mm, respectively, there is the possibility that the surface skin 60 may lose shape.

In the construction described hereinabove, as shown in FIG. 2, of the cushioning material 62, only the predetermined region R confronting the grip area 66 of the hand strap 56 is tenderized. Accordingly, an undesirable reduction in cushioning characteristic during the seating can be avoided while an undesirable softening of the seating region S is avoided, and also the fingers can readily be inserted in between the surface skin 60 and the hand strap 56 to facilitate a gripping of the hand strap 56.

Also, since the grip area 66 of the hand strap 56 is disposed in the front end face 64 of the seat main body 54, an improved appearance can be obtained. In such case, as compared with the case in which the hand strap is disposed on the upper surface of the seat main body 54, the hand strap 56 is so shortened enough to reduce the amount of deformation, but since the predetermined region R is tenderized, the hand strap 56 can readily and easily be gripped.

In addition, since the cushioning material 62 in the predetermined region R has the contact area 86 that contacts the surface skin 60, the contact area 86 will not lose shape and the surface skin 60 can be set up to an intended shape.

Yet, since the cavity 88 is formed on the side opposite to the surface skin 60 against the contact area 86, the predetermined region R can be tenderized with a simplified structure.

That portion of the grip area 66 of the hand strap 56, which is intermediate of the motorcycle widthwise direction (opposite lateral directions of the motorcycle) is generally gripped, and as shown in FIG. 3 the cavity 88 is formed in that portion of the seat main body 54 intermediate of the motorcycle widthwise direction. Accordingly, as a result that the intermediate portion of the seat main body 54 with respect to the motorcycle widthwise direction is tenderized, an operation to grip the gripping area 66 with the fingers inserted in between the grip area 66 and the surface skin 60 can be facilitated. Also, the possibility of losing shape of the surface skin 60 at the motorcycle widthwise direction opposite end portions, where the opposite end portions 57 of the hand strap 56 are located, can be avoided.

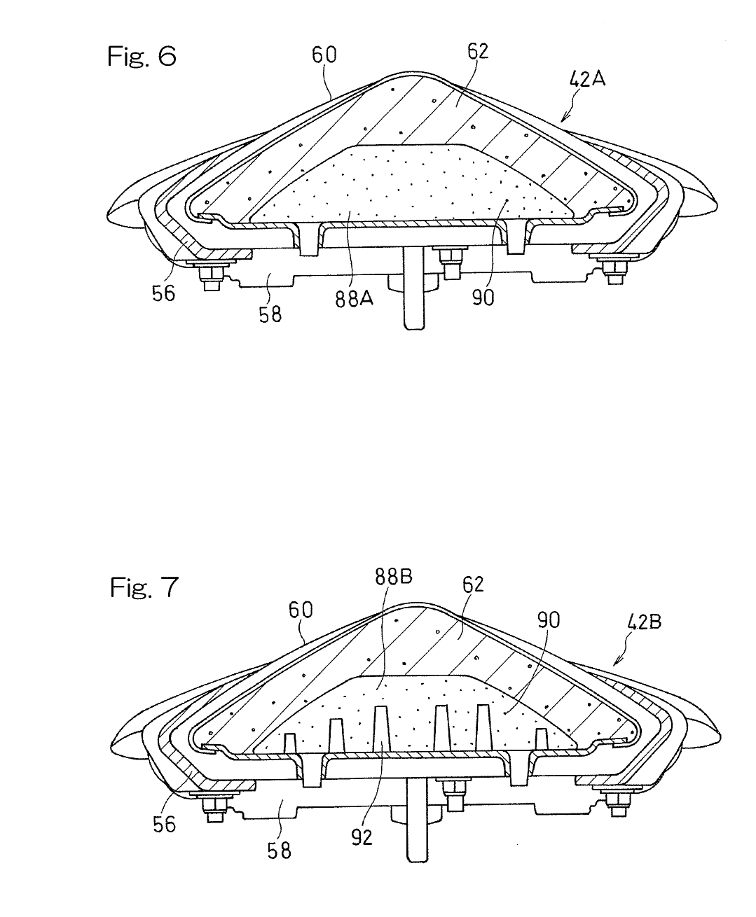

FIG. 6 illustrates a transverse sectional view showing the fellow passenger's seat, now identified by 42A, designed in accordance with a second preferred embodiment of the present invention. In this fellow passenger's seat 42A according to the second embodiment, a recess 88A open downwardly of the cushioning material 62 is not a cavity, but has a soft sponge material 90 having a higher flexibility than that of the cushioning material 62 filled therein. Other structural features thereof are similar to those shown and described in connection with the previously described first embodiment. Even in this second embodiment, effects similar to those described in connection with the first embodiment can be obtained.

FIG. 7 illustrates a transverse sectional view showing the fellow passenger's seat, now identified by 42B, designed in accordance with a third preferred embodiment of the present invention. In this fellow passenger's seat 42B according to the third embodiment, the sponge material 90 within a recess 88B has cutouts 92 formed intermittently. Accordingly, the sponge material 90 is further tenderized. Other structural features thereof are similar to those shown and described in connection with the previously described second embodiment. Even in this third embodiment, effects similar to those described in connection with any one of the first and second embodiments can be obtained.

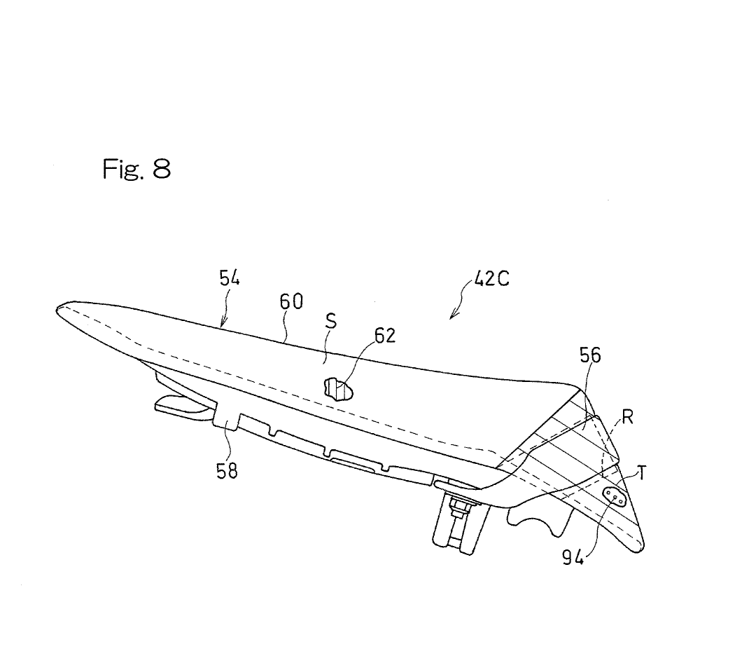

FIG. 8 illustrates a transverse sectional view showing the fellow passenger's seat, now identified by 42C, designed in accordance with a fourth preferred embodiment of the present invention. In this fellow passenger's seat 42C according to the fourth embodiment, no recess such as the cavity 88 or the recess 88A or 88B, which have been shown and described as employed in the practice of any one of the first to third embodiments, is employed. In the practice of this fourth embodiment, a second cushioning material 94 within a large region T including the predetermined region R and its vicinity is replaced with a raw material softer than the cushioning material 62 employed in the region including the seating region S and, thereby, the predetermined region R is tenderized. Other structural features thereof are similar to those shown and described in connection with the previously described first embodiment. Even in this second embodiment, as is the case with any one of the previously described embodiments, an undesirable reduction in cushioning characteristic during the seating can be avoided while an undesirable softening of the seating region S is avoided. Also the fingers can readily be inserted in between the surface skin 60 and the hand strap 56 to facilitate a gripping of the hand strap 56.

In the practice of the fourth embodiment, the second cushioning material 94, which is a soft raw material, is filled in the region including the predetermined region R, but the predetermined region R can be tenderized by filling therein a cushioning material, which is similar to the cushioning material 62, and then reducing the filling rate in that region R over to the filling rate in the seating region S.

Although the present invention has been fully described in connection with the preferred embodiments thereof with reference to the accompanying drawings which are used only for the purpose of illustration, those skilled in the art will readily conceive numerous changes, modifications and deletions within the framework of obviousness upon the reading of the specification herein presented of the present invention. By way of example, although in describing any one of the foregoing embodiments, the hand strap 56 has been provided in the front end face 64 of the seat main body 54, the position of the hand strap 56 may be other than the front end face 64.

Also, the present invention, although having been described as applied to the fellow passenger's seat 42, can be equally applied to a double seat assembly of one piece construction including the rider's seat and the fellow passenger's seat, and the hand strap 56 may be provided in a rear portion of the rider's seat 40.

Yet, the present invention can also be applied to any other saddle riding type automotive vehicle than the motorcycle, such as, for example, a tricycle or a four wheeled vehicle.

Accordingly, such changes and modifications are, unless they depart from the scope of the present invention as delivered from the claims annexed hereto, to be construed as included therein.

### REFERENCE NUMERALS

42, 42A, 42B, 42C . . . Fellow passenger's seat
54 . . . Seat main body
56 . . . Hand strap
60 . . . Surface skin
62 . . . Cushioning material
64 . . . Front end face of the seat main body
66 . . . Grip area
86 . . . Contact area
88 . . . Cavity (Recess)
88A, 88B . . . Recess
R . . . Predetermined region
S . . . Seating region

What is claimed is:

1. A seat assembly for a saddle riding type automotive vehicle, which comprises:
a seat main body having a cushioning material covered by a surface skin, and
a hand strap disposed in the seat main body and adapted to be gripped by a fellow passenger; wherein
a predetermined region of the cushioning material, which confronts a grip area of the hand strap, is more tenderized than a seating region on which a rider is seated.

2. The seat assembly as claimed in claim 1, wherein the hand strap is such that the grip area is disposed in a front end face of the seat main body.

3. The seat assembly as claimed in claim 1, wherein the cushioning material within the predetermined region has a contact area that contacts the surface skin.

4. The seat assembly as claimed in claim 3, wherein against the contact area, a cavity is formed on one side opposite to the surface skin to thereby permit the predetermined region to be tenderized.

5. The seat assembly as claimed in claim 4, wherein the cavity is formed in a portion of the seat, which is intermediate with respect to a direction widthwise of the vehicle.
